(19) United States
(12) Patent Application Publication
(10) Pub. No.: US 2020/0149943 A1
(43) Pub. Date: May 14, 2020

(54) Apparatus and Method for Measuring and Tracking Container Contents

(71) Applicant: Josh Lee, New Holland, PA (US)

(72) Inventor: Josh Lee, New Holland, PA (US)

(21) Appl. No.: 16/577,935

(22) Filed: Sep. 20, 2019

Related U.S. Application Data
(60) Provisional application No. 62/743,521, filed on Oct. 9, 2018.
(60) Provisional application No. 62/743,521, filed on Oct. 9, 2018.

(51) Int. Cl. G01F 9/00; B65D 85/52; B65D 23/16; B65D 25/20; G10L 15/22; A61J 1/00; G06Q 10/08

(52) U.S. Cl. CPC G01F 9/003; B65D 85/52; B65D 23/16; G10L 2015/223; G10L 15/22; A61J 1/00; G06Q 10/087; B65D 25/20

(57) ABSTRACT

The invention provides an apparatus and method for measuring and tracking the contents of a container. The invention integrates a container with a scale and other sensors and provides software to track properties of the container's contents. Measurements are recorded on the device and sent via software app to an associated computing device. The system provides a convenient way to monitor input and output from the container and observe consumption patterns. One purpose of the device is to enable users to monitor consumption of medicines. Another purpose of the device is to enable users to secure valuable items against unauthorized use. The invention further enables measurements in the field that might otherwise be impractical.

### FIELD OF INVENTION

The invention relates to several fields the first of which is determining weights by use of scales. The field of the invention also relates to consumer electronics products and updating scientific or industrial devices to enable more convenient use by ordinary consumers. The field of the invention is also medical devices because the device is well suited to the storage and dispensation of pharmaceuticals or materials with pharmacological value. The field of the invention is also computer software, information technology and the internet. The field of the invention is also machine learning, artificial intelligence and the internet of things.

### BACKGROUND OF THE INVENTION

Though well known in the art, devices for measuring weight and other physical properties are predominantly designed for laboratory, industrial, or domestic use. Few scales are designed for personal and mobile use. Few scales have been disclosed that are designed to be permanently attached to a sealable container for ease of handling and transportation or that measure and track physical properties for the purpose of data collection, aggregation, reporting and analysis. Few scales have been disclosed that are designed to be integrated with the internet and function as part of the internet of things. Few scales have been disclosed that are integrated with computer software and employ machine learning and artificial intelligence to track and evaluate items carried in containers attached to scales.

### RELATED ART

CN104296853 (A)—Pen container with weighing function

CN204556068 (U)—Container sensor weighing module

### BRIEF SUMMARY OF THE INVENTION

Accordingly, an object of the present invention is to provide a carrying container that can measure, record and report the weight of the contents.

Accordingly, another an object of the present invention is to provide a carrying container that can measure, record, report and track the weight of a large variety of cargo

Another object of the present invention is to provide a carrying container of varying sizes that can store and sense a range of physical properties.

Another object of the present invention is to provide a carrying container that can measure, record, report and track the temperature of the contents.

Another object of the present invention is to provide a carrying container that can measure, record, report and track the humidity of the contents.

Another object of the present invention is to provide a carrying container that can measure, record, report and track the name of the contents.

Another object of the present invention is to provide a carrying container that records, reports and tracks metadata and other related information about the contents.

Another object of the present invention is to provide a carrying container that may be charged by universal serial bus (USB).

Another object of the present invention is to provide a carrying container that communicates with an associated computing device by USB.

Another object of the present invention is to provide a carrying container that communicates with an associated computing device wirelessly.

Another object of the present invention is to provide a carrying container that may submit purchase and delivery orders over the internet.

Another object of the present invention is to provide a carrying container that measures weight with a high accuracy.

Another object of the present invention is to provide a carrying container that optimizes the use of space by offsetting the center of gravity of the inner liner.

Another object of the present invention is to provide a carrying container that configured to utilize a variety of loadcell types.

Another object of the present invention is to provide a carrying container that reports tracked information by use of a digital display.

Another object of the present invention is to provide a carrying container that has a QR code reader which identifies contents by reading QR codes on packaging of items added to the container.

Another object of the present invention is to provide a carrying container that has a lockable lid.

Another object of the present invention is to provide a carrying container that has a child proof lid.

Another object of the present invention is to provide a carrying container made from an electrochromic material.

Another object of the invention is to provide a carrying container that has a speaker enabling it to play music and make intelligible statements about the container and its contents.

Another object of the present invention is to provide a carrying container that has a microphone enabling to respond to commands and questions.

Another object of the present invention is to provide a smart carrying container that is integrated with computer software.

Another object of the present invention is to provide a smart carrying container with computer software enabled to employ machine learning and artificial intelligence to track and evaluate items carried in the container.

Another object of the present invention is to provide a smart carrying container that collects, aggregates, reports and analyzes data.

Another object of the present invention is to provide a smart carrying container that is part of the internet of things.

Another object of the present invention is to provide a smart carrying container that is integrated with the internet and may upload and download data from the internet.

Another object of the present invention is to provide a smart carrying container that enables easy personal and mobile use.

Another object of the present invention is to provide a smart container that manages usage history by weight, day, time and contents identifier.

Another object of the present invention is to provide a smart container that is well suited to tracking consumption of cannabis and other items of pharmacological value.

Another object of the present invention is to provide a smart container that tracks and predicts user habits.

Another object of the present invention is to provide a smart container that has associated software which engages in predictive analytics.

Another object of the present invention is to provide a smart container that enables users to learn about their consumption of items stored in the container.

Another object of the present invention is to provide a smart container that provides users with tools to manage their consumption of items stored in the container.

Another object of the present invention is to provide a smart container that enables producing higher quality medicinal products based upon trends and patterns found in usage data.

Another object of the invention is to provide a carrying container that is autonomously mobile and can pick up objects and sense a range of physical properties about those objects.

Another object of the invention is to enable release of scents and odors emitted by the contents of the container to the outside of the container upon command.

Another object of the present invention is to provide a smart carrying container that is water proof.

Another object of the present invention is to provide a smart carrying container that is smell proof.

The present invention achieves its objects by providing an apparatus and method to measure, record, report and track the contents of a container. The manners in which the invention achieves its objects and other objects which are inherent in the invention will become more readily apparent when reference is made to the accompanying figures.

### BRIEF DESCRIPTION OF THE DRAWINGS

The above and other objects and features of the present invention will become apparent from the following description of the invention, when taken in conjunction with the accompanying drawings wherein,

FIG. 1 Exploded view of an embodiment of the apparatus

FIG. 2 Cross-sectional view of an embodiment of the apparatus

FIG. 3 Alternate views of an embodiment of the apparatus

FIG. 4 Partial view of an embodiment of the apparatus.

FIG. 5 Perspective view of the inner liner of an embodiment of the apparatus.

FIG. 6 An exemplary user interface associated with tracking consumption of medication in accordance with embodiments of the present invention.

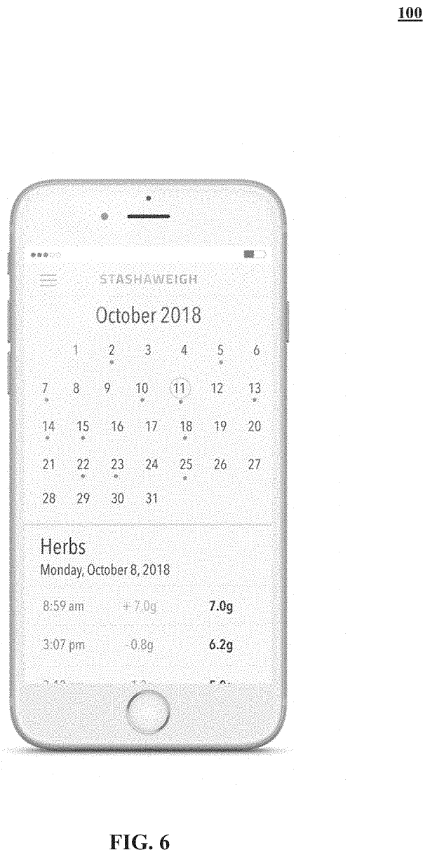

FIG. 7 An exemplary user interface associated with tracking consumption of medication in accordance with embodiments of the present invention.

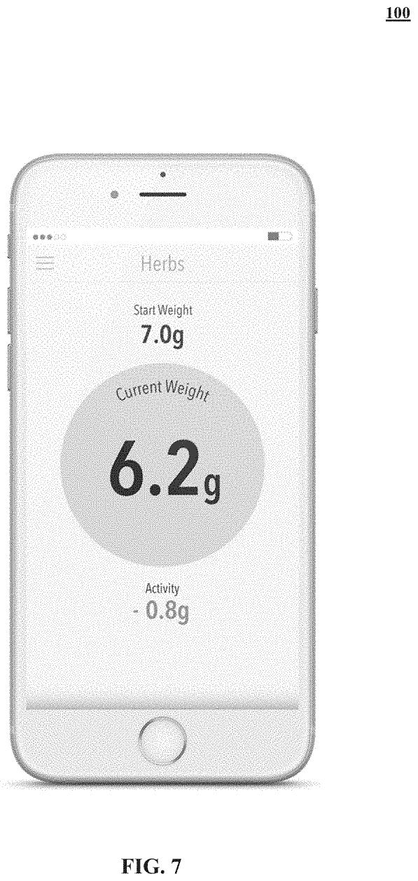

FIG. 8 An exemplary user interface associated with tracking consumption of medication in accordance with embodiments of the present invention.

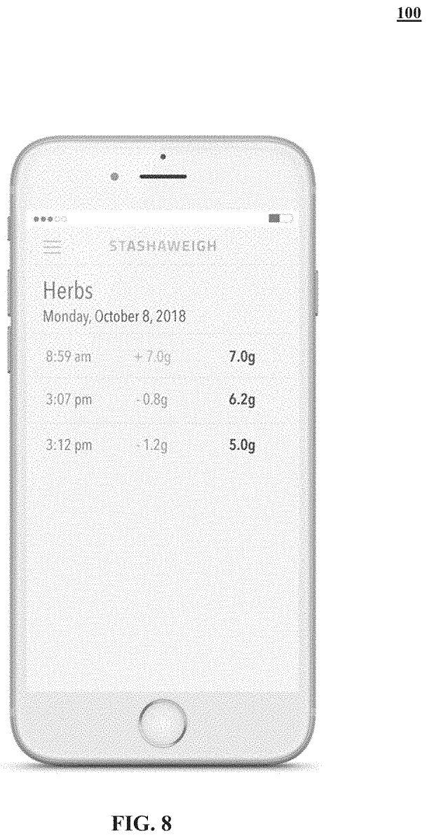

FIG. 9 Illustrates a flow diagram of an embodiment according to the invention.

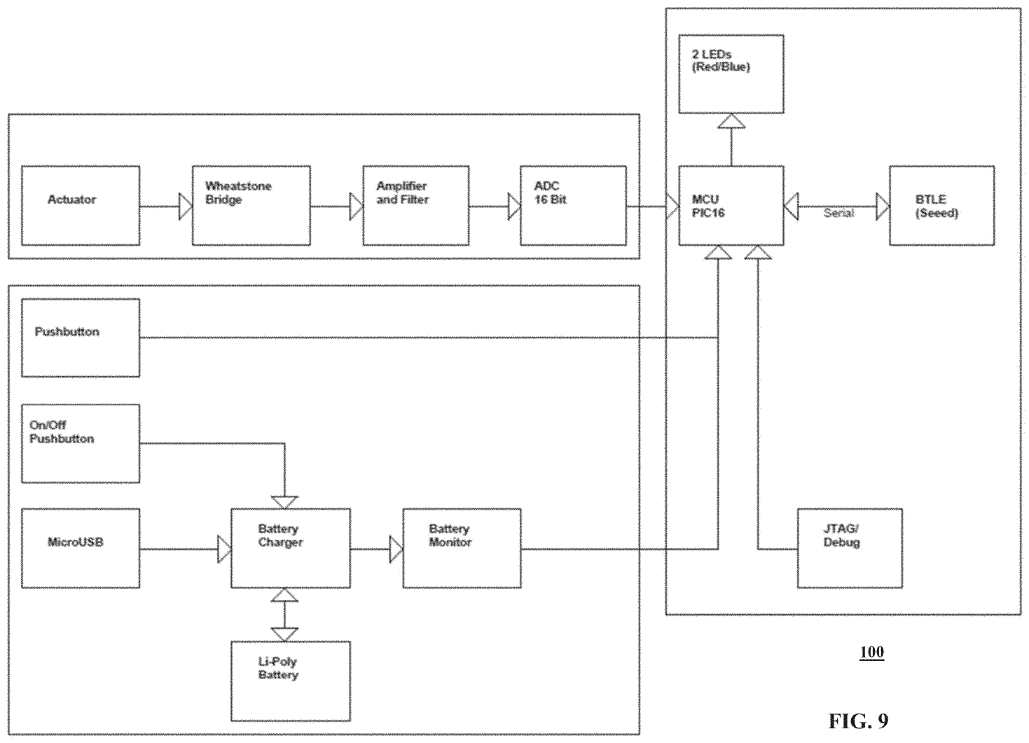

FIG. 10 Illustrates a circuit diagram of an embodiment according to the invention.

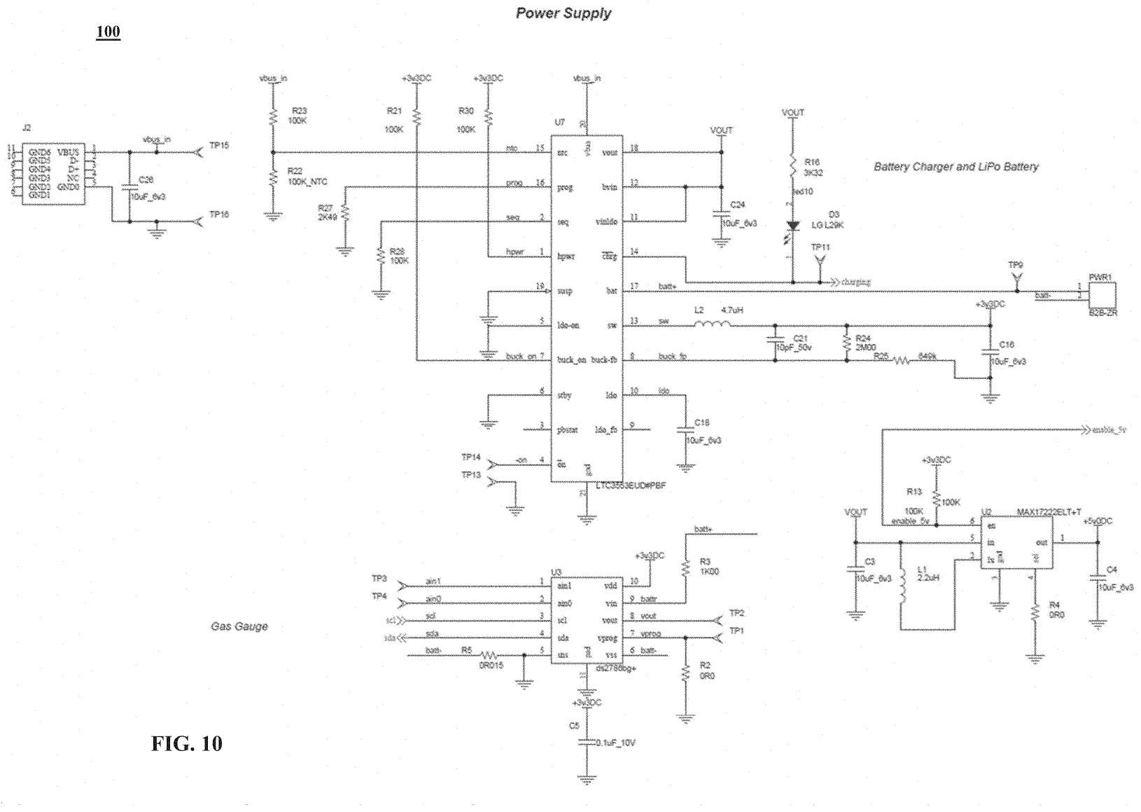

FIG. 11 Illustrates a circuit diagram of an embodiment according to the invention.

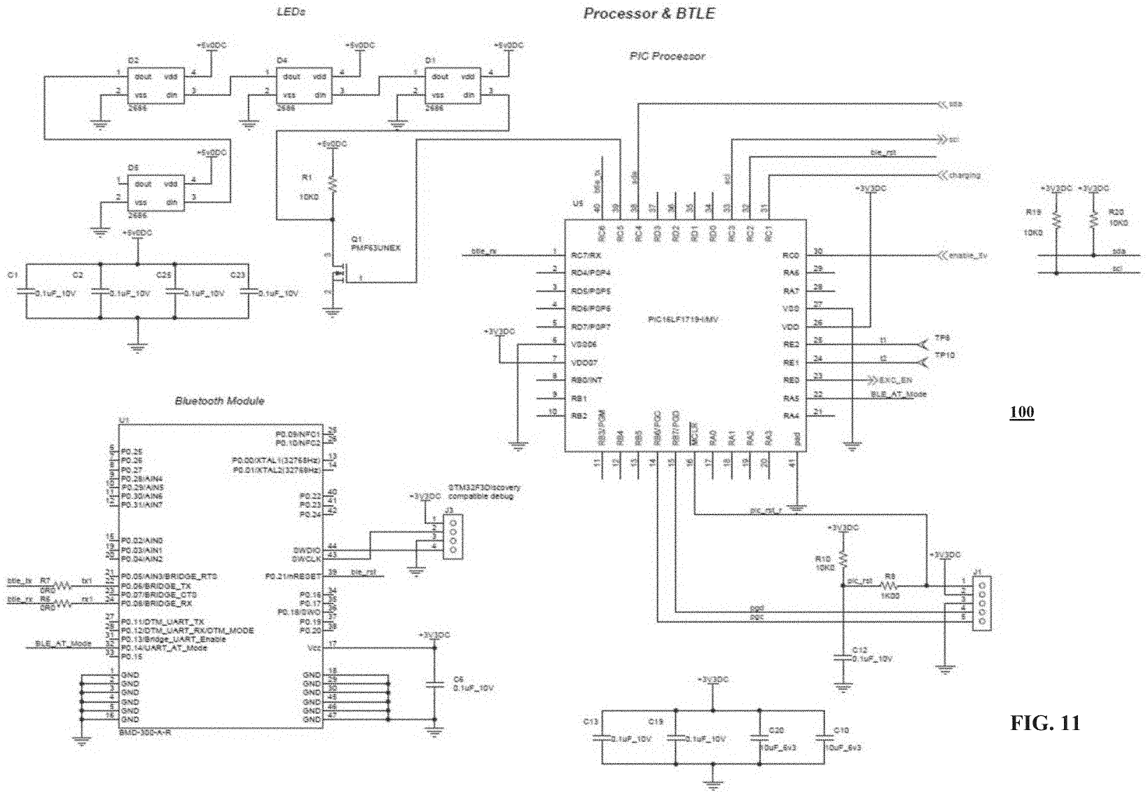

FIG. 12 Illustrates a circuit diagram of an embodiment according to the invention.

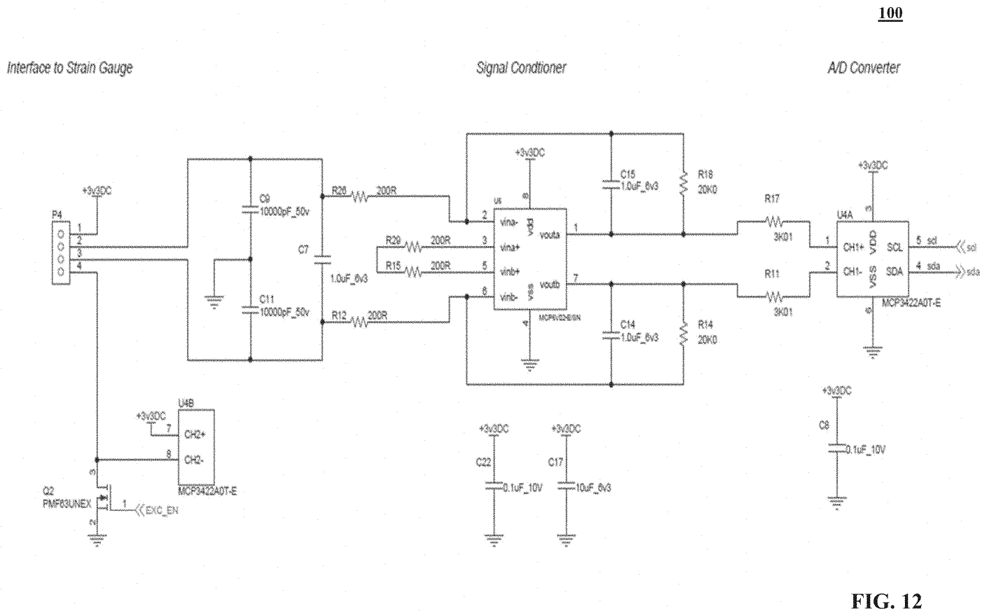

### DETAILED DESCRIPTION OF THE INVENTION

Referring now to the drawings wherein the showings are for purposes of illustrating the preferred embodiment of the present invention and not for purposes of limiting the same.

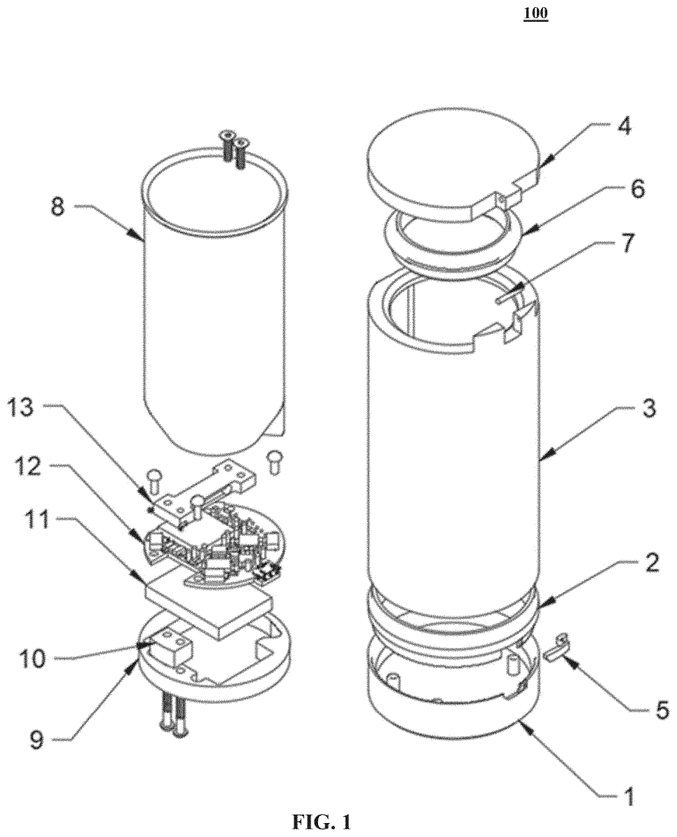

FIG. 1 shows the measuring and tracking apparatus 100. The apparatus 100 is disposed with a cylindrical container body 3 which in this embodiment is made from aluminum but in other embodiments could be made from other suitable materials including but not limited to titanium, brass, steel, stainless steel, copper, Acrylonitrile Butadiene Styrene (ABS), Polyethylene, Polycarbonate, Polyamide (Nylon), High Impact Polystyrene (HIPS), Polypropylene, Polyoxymethylene (POM), Polypropylene, Acetal-Polyoxymethylene, Low-Density polyethylene (LDPE), fiberglass, carbon fiber and ceramics. In this embodiment the apparatus 100 is designed to be six inches tall and two inches in diameter and is capable of storing and weighing up to 100 grams, but in other embodiments could be non-cylindrical, and may be as large as a 55 gallon drum and weigh significantly heavier contents. Container body 3 is attached at its basal end by screw threads disposed around the cylinder inner circumference to an upper or apical side of a light ring 2 disposed with screw threads around the outer circumference. The basal end of said light ring 2 is similarly attached by screw threads disposed around its outer circumference to an exterior base 1 disposed with screw threads around the inner circumference. The other embodiments the various components could be attached and connected by other means.

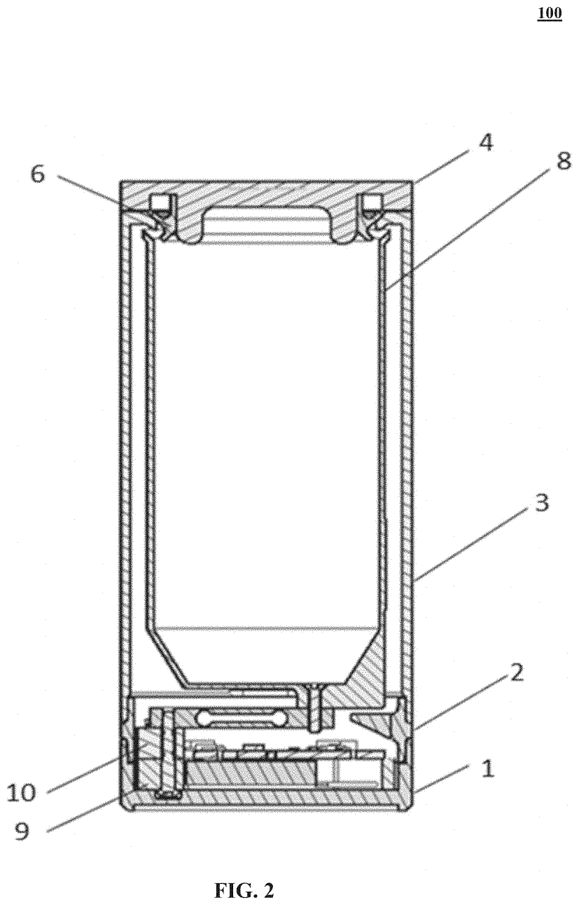

The upper end of said container body 3 is affixed to a lid 4 by way of a hinge pin 7 positioned through a tongue disposed at one side of said lid 4 that fits inside a groove disposed at the upper outside edge of the container body 3. The lower and interior surface of said lid 4 is disposed with a gasket 6 that seals the contents of the container against outside air and contacts the apical circumference of an inner liner 8 when the container is closed, FIG. 2.

Returning now to said exterior base 1, the apically facing interior surface of said exterior base 1 is disposed with three screw holes upon which sits an inner base 9. Upon the apically facing surface of said inner base 9 and displaced to one side is a loadcell spacer 10 affixed by apically directed screws inserted through the bottom of said inner base 9. Adjacent to the loadcell spacer 10 and in a slightly lower horizontal plane is a battery 11 which rests in a cutout within said inner base 9. In this embodiment said battery 11 is a lithium-ion battery but in other embodiments could be any other suitable battery. Upon the apically facing surface of said battery 11 and fitting around the loadcell spacer 10 by way of a groove is a circuit board 12 disposed with a universal serial bus (USB) jack and led lights. Said circuit board 12 is attached to the interior base 9 by three basally directed screws that pass through said circuit board 12 and through said inner base 9 and join to the exterior base 1 screw holes. The USB jack is accessed via a port in the side of said light ring 2 and is disposed with a removable cover 5. Light emitting diode (LED) lights on said circuit board 12 shine through said light ring 2 to indicate the power status of the device. Upon the apically facing surface of said loadcell spacer 10 and electrically connected to said circuit board 12 is a loadcell 13 which is capable of measuring weight down to milligrams. Said loadcell 13 is affixed on a proximal end to the loadcell spacer 10 at a point near the outer diameter of apparatus 100 by the two apically directed screws passing through the inner base 9 and loadcell spacer 10. In this embodiment the loadcell 13 utilizes a wheatstone bridge sensor but in other embodiments may be a hydraulic, pneumatic, piezoelectric, or another type of sensor. In this embodiment the apparatus 100 is capable of determining weights to the thousandth of a gram, or one milligram, but in other embodiments the apparatus 100 may be capable of measuring weights at higher resolution with more significant digits or lower resolution with fewer significant digits.

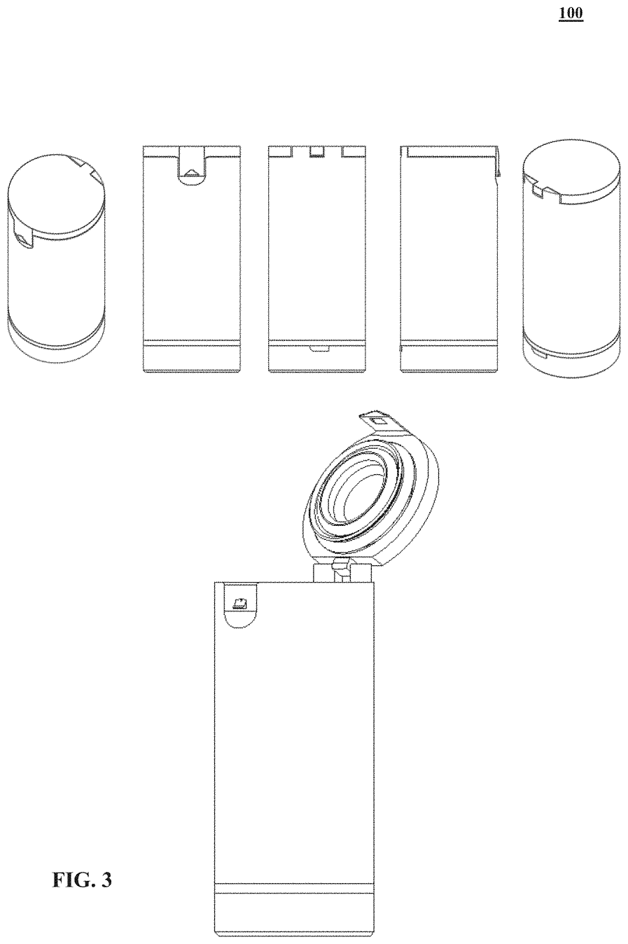

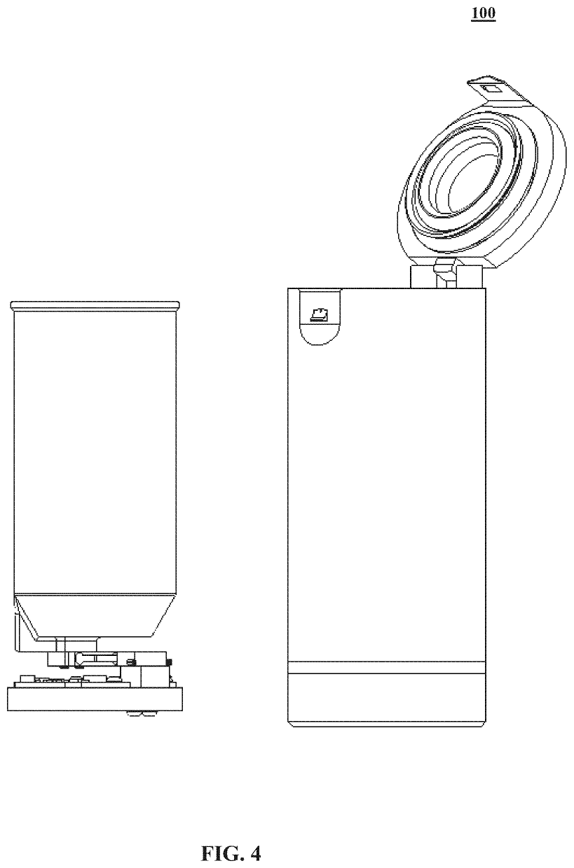

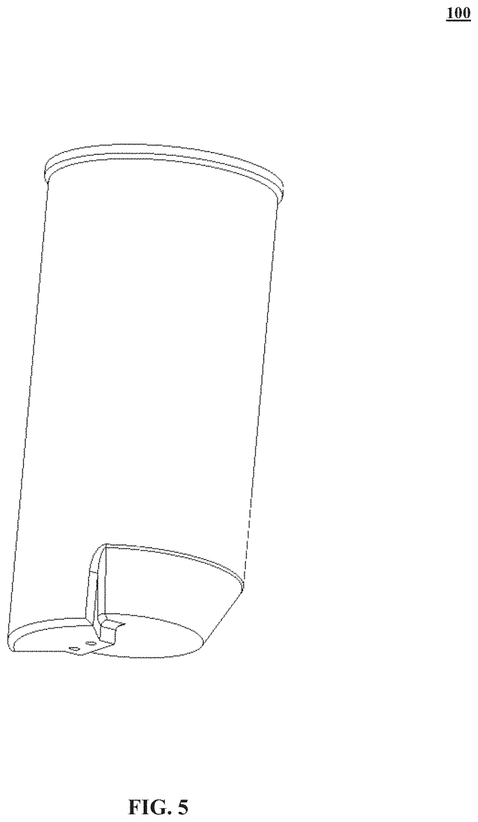

Resting atop the load cell 13 is an inner liner 8. Said inner liner 8 is designed so that its center of gravity is offset to one side of its basal surface towards a point nearer its outer diameter than the center, FIG. 5. The displacement of the center of gravity towards the circumferential edge of the inner liner 8 enables said inner liner 8 to rest at the most distal end of said load cell 13. The inner liner 8 is affixed to the distal end of the load cell 13 by two basally directed screws which pass through said inner liner 8 into the load cell 13. The inner liner 8 and scale system are designed so that they do not make contact with the exterior housing 3 when the lid 4 is in the open position, FIGS. 2-4. This enables said inner liner 8 and said scale system to act independently of said exterior housing 3 providing a highly accurate portable scale system

In alternate embodiments apparatus 100 may be further disposed with a QR code reader. Said QR code reader is oriented to look outside the container so that users may scan product packages before placing items inside the container 100. In an embodiment the QR code readable information consists of a pharmaceutical name, concentration and dosage information, and the stated weight of the product in the original package. Many other kinds of information and metadata may be also be acquired by the QR code reader. In alternate embodiments apparatus 100 will communicate data wirelessly, in one embodiment using Bluetooth® but in other embodiments by WiFi, via the cellular network or any other available wireless standard. Transmitted data is sent to a computing device via a software application designed to work with apparatus 100. Data may also be retrieved from apparatus 100 by way of the USB port 5. The software application will record and analyze transmitted data to provide useful metrics. The software application will also collect information from the internet that is relevant to the container contents and incorporate that information into reports generated by the software application. Apparatus 100 is toggled between on and sleep modes by way of the connected software application. Apparatus 100 is also disposed with a sleep function that will power it off after a period of time without use. Each apparatus 100 is paired to an associated computing device by the software application such that each computing device will only recognize apparatuses that have been paired.

In yet a further embodiment, apparatus 100 is disposed with a thermometer and hygrometer located with access to the space inside the inner liner 8 and connected to the circuit board 12 in order to monitor and report temperature and humidity inside the apparatus 100. In other embodiments apparatus 100 may be further disposed with a locking lid 4 that provides child proofing. Said locking lid 4 may have a combination lock disposed upon it or in other embodiments may be fingerprint activated or voice activated through a microphone on the apparatus 100, or voice activated through the connected computing device or locked by a puzzle code. In an embodiment, apparatus 100 may be further disposed with an electrochromic container body which darkens with exposure to sunlight and lightens in low light allowing the contents to be more easily viewed.

In other embodiments, apparatus 100 may be further disposed with a removable inner liner. Apparatus 100 may also be autonomously mobile being disposed with wheels and a motor enabling it to move around on the floor. Said mobile apparatus 100 is enabled to pick items up off the floor and determine their weight and other physical properties and report this information to associated computing devices. In still further embodiments, apparatus 100 will determine when the contents of a container are running low and reorder them using connected software applications and an internet connection. In still further embodiments apparatus 100 may be disposed with a speaker which enables it to state in human languages data including but not limited to content name, weight, temperature, humidity, reorder status, and battery level. Said speaker may also be capable of playing music. Said speaker may also be capable of giving alerts concerning the contents and their physical condition. In still further embodiments, apparatus 100 is disposed with an associated software application which uses applied machine learning algorithms and artificial intelligence. Collected data is used to establish analytics, patterns, efficiency predictions, and user habits based upon weight time and day. In yet still further embodiments, the LED lights disposed upon the circuit board 12 transition from blue to yellow light when the battery reaches the 20% discharge threshold and turn red when the battery reaches 10% remaining charge. When the battery is being charged by USB, a separate LED is lit green to indicate charging status. The associated software application also contains a battery indicator.

In still further embodiments, the associated software application runs on a mobile phone and is designed to show and track the history of each “session” of use when a user turns on and uses the apparatus 100. When the apparatus 100 is empty and the scale reads 0.000 the associated software application gives the user a field to add details of what they are putting in the container and the date is recorded for representation on a calendar. Once details identifying what is being added to the apparatus 100 are entered the software application takes the user to the main weight screen. When the user starts a consumption session, the device will start tracking changes in the weight of items in the apparatus 100. The main weight screen shows “Start Weight”, “Current Weight” and “Activity”. These weight data points are based on each “session” that is recorded when users turn on the app. The “start weight” shows the weight data when a user last turned off the device/app and what that previous session weight ended at. The “activity” is based on that current session from the user. The “current weight” shows the deduction from the “Start weight” that the user started with and the “activity” during the session. When clicking a top left hamburger menu the user is taken to a history calendar. The history calendar shows a red dot under a date which signifies the occurrence of a session on that date. If the user clicks on that day with a red dot, details will be displayed below about the time and activity on that date. If the user clicks on that newly displayed detail information, the software application will take the user to another display which shows the enlarged session history screen. The user can then go back to the main weight screen and continue their session. When the container is not empty and the device and software application are turned off the software application will save the last weight measurement so that when the device is turned back on it will show any adjustments made while the device was off. This step will reflect any lost weight based on changes in temperature or humidity. This step will also show if any of the container contents were removed without the users knowledge. The software application is tied to the user and the user only ensuring the security to the contents of the apparatus 100.

It will be understood that various modifications can be made to the various embodiments of the present invention herein disclosed without departing from the spirit and scope thereof. Therefore, the above description should not be construed as limiting the invention, but merely as an exemplification of preferred embodiments thereof. Those of skill in the art will envision other modifications within the scope and sprit of the present invention as defined by the claims appended hereto.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. An apparatus for measuring, recording, reporting and tracking container contents comprising:
a. A container body;
b. An inner liner;
c. An integrated scale;
d. A USB port.

2. The apparatus of claim 1 wherein the inner liner and scale act independently of the exterior housing.

3. The apparatus of claim 1 further comprised of a thermometer and hygrometer.

4. The apparatus of claim 1 wherein the apparatus communicates with an associated computing device wirelessly.

5. The apparatus of claim 1 wherein the associated computing device aggregates reported data and generates reports.

6. The apparatus of claim 1 further comprising a QR code reader.

7. The apparatus of claim 1 further comprising a locking lid.

8. An apparatus for measuring, recording, reporting and tracking container contents comprising:
a. A container body;
b. An exterior base;
c. An airtight lid;
d. An indicator light;
e. An inner liner;
f. An integrated scale
g. A battery;
h. A USB port.

9. The apparatus of claim 8 wherein the inner liner and scale act independently of the exterior housing.

10. The apparatus of claim 8 wherein the apparatus communicates with an associated computing device wirelessly.

11. The apparatus of claim 8 further comprised of a thermometer and hygrometer.

12. The apparatus of claim 8 wherein the associated computing device aggregates reported data and generates reports.

13. The apparatus of claim 8 further comprising a QR code reader.

14. The apparatus of claim 8 further comprising a locking lid.

15. A method of measuring, recording, reporting and tracking container contents comprising:
a. Adding material to an apparatus capable of measuring, recording, reporting and tracking container contents;
b. Measuring the weight of said contents;
c. Recording the weight of said contents;
d. Reporting the weight of said contents;
e. Removing material from said apparatus;
f. Measuring, recording, and reporting the weight of said contents;
g. Generating reports about the weight of said contents over time;
h. Transmitting said reports to an associated computing device.

16. The method of claim 15 further comprising measuring, recording, reporting, generating reports about the temperature and humidity of said contents over time and transmitting said reports to a computing device.

17. The method of claim 16 further comprising reading a QR code on the original package of materials to be added to the apparatus and transmitting this information to a computing device.

18. The method of claim 17 further comprising locking the apparatus for measuring, recording, reporting, tracking and transmitting data when the apparatus is not in use.

19. The method of claim 18 further comprising automatically reordering contents from a vendor over the internet when the container contents run low.

20. The method of claim 19 further comprising giving oral commands and receiving computer generated audible responses concerning the contents of the apparatus, related information and also including playing of music from the apparatus
